(19) United States
(12) Patent Application Publication
(10) Pub. No.: US 2013/0222296 A1
(43) Pub. Date: Aug. 29, 2013

(54) MOBILE DEVICE AND METHOD FOR PROVIDING OBJECT FLOATING OPERATION

(71) Applicant: Pantech Co., Ltd., (US)

(72) Inventor: Dong Hwa PAEK, Seoul (KR)

(73) Assignee: Pantech Co., Ltd., Seoul (KR)

(21) Appl. No.: 13/734,424

(22) Filed: Jan. 4, 2013

(30) Foreign Application Priority Data
Feb. 29, 2012 (KR) 10-2012-0021479

(51) Int. Cl. G06F 3/01

(52) U.S. Cl. CPC G06F 3/01
USPC 345/173

(57) ABSTRACT

A mobile device includes a touch input display to display a first object in a first screen image and to receive a first touch input corresponding to the first object, a floating execution unit to switch the first object into a floated state in response to the first touch input, and to generate a floating window for displaying the first object in the floated state, the floated first object being configured to be displayed in the floating window along with a second screen image if the first screen image is replaced with the second screen image, and a controller to associate information of the first object with the second screen image or with an application corresponding to the second screen image.

### CROSS-REFERENCE TO RELATED APPLICATIONS

This application claims priority from and the benefit under 35 U.S.C. §119(a) of Korean Patent Application No. 10-2012-0021479, filed on Feb. 29, 2012, which is incorporated herein by reference as if fully set forth herein.

### BACKGROUND

1. Field

The present disclosure relates to a mobile device and method for providing a touch input user interface, and more particularly, to a mobile device and method for providing an object floating operation.

2. Discussion of the Background

Nowadays, there is a tendency that electronic apparatuses are equipped with is multi-functions in order to provide the users with more convenient user interfaces. Furthermore, electronic apparatuses having an intuitive user interface, such as touch screen devices, have been widely spread.

However, since an electronic apparatus may provide a complex function to execute certain operations or applications, the user may feel inconvenience due to the complicated instructions or manipulations of the electronic apparatus or may execute a desired application through complicated multiple stages of manipulations in many cases.

Thus, there has been a strong demand for the development of an electronic apparatus providing an intuitive user-friendly interface.

### SUMMARY

Exemplary embodiments of the present invention provide a mobile device capable of executing an application by floating a graphic object using a multi-touch input and analyzing first-touch graphic object information, second-touch information, and first-touch graphic object dropped region information and relates to an execution method using the same.

Additional features of the invention will be set forth in the description which follows, and in part will be apparent from the description, or may be learned by practice of the invention.

Exemplary embodiments of the present invention provide a mobile device, including: a touch input display to display a first object in a first screen image and to receive a first touch input corresponding to the first object; a floating execution unit to switch the first object into a floated state in response to the first touch input, and to generate a floating window for displaying the first object in the floated state, the floated first object being configured to be displayed in the floating window along with a second screen image if the first screen image is replaced with the second screen image; and a controller to associate information of the first object with the second screen image or with an application corresponding to the second screen image.

Exemplary embodiments of the present invention provide a method for providing an object floating operation, including: receiving a first touch input corresponding to a first object displayed in a first screen image; switching the first object into a floated state in response to the first touch input; generating a floating window for displaying the first object in the floated state, the floated first object being configured to be displayed in the floating window along with a second screen image if the first screen image is replaced with the second screen image; and associating information of the first object with the second screen image or with an application corresponding to the second image.

Exemplary embodiments of the present invention provide a method for providing an object floating operation, including: receiving a first touch input corresponding to a first object displayed in a first screen image; switching the first object into a floated state in response to the first touch input; receiving a second touch input associated with a second object; and generating a floating object group for displaying the first object and the second object in a floated state.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic configuration diagram illustrating a mobile device having a graphic object floating function according to an exemplary embodiment of the present invention.

FIG. 2 is a schematic configuration diagram illustrating a control unit shown in FIG. 1 according to an exemplary embodiment of the present invention.

FIG. 3 is a diagram illustrating an example of a manifest file of a target application according to an exemplary embodiment of the present invention.

FIG. 4 is a diagram illustrating a display unit on which a plurality of windows is displayed according to an exemplary embodiment of the present invention.

FIG. 5 is a flowchart illustrating a method for processing a floated graphic object according to an exemplary embodiment of the present invention.

FIGS. 6 to 12 are examples illustrating a method for processing a graphic object floating function according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

Hereinafter, a mobile device having a graphic object floating function and an execution method using the same will be described in detail by referring to the accompanying drawings.

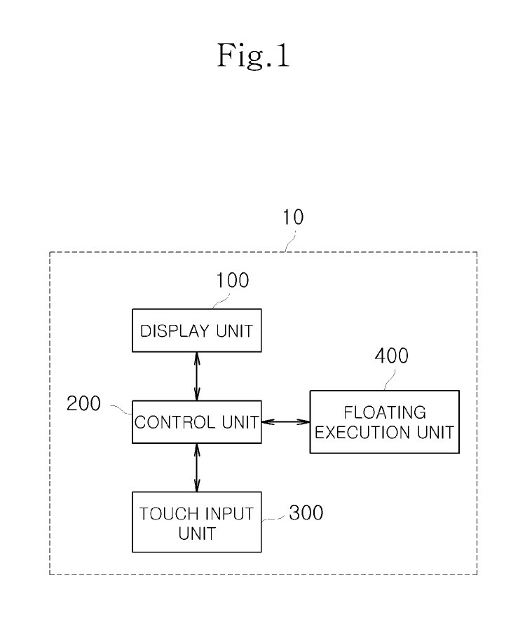

FIG. 1 is a schematic configuration diagram illustrating a mobile device having a graphic object floating function according to an exemplary embodiment of the present invention.

Referring to FIG. 1, a mobile device 10 includes a display unit 100, a control unit 200, a touch input unit 300, and a floating execution unit 400.

The display unit 100 may display an application executed in the mobile device 10 thereon and switch a screen in response to the control of the control unit 200 or display the execution state of the application in response to a command signal input to the mobile device 10. Further, a selectable graphic object may be displayed on the display unit 100. The selectable graphic object may be selected in response to a first touch input corresponding to the selectable graphic object, and the graphic object selected by the first touch input may be changed to a floated state by the floating execution unit 400. Here, the floated state may indicate a selected state by a user such that the graphic object is in the state of shaking or the selected graphic object displays on a layer of the other graphic object. The graphic object may include at least one of a shortcut, an icon, and a thumbnail of an application, a document, and a multimedia file. The display unit 100 may be configured as, for example, a touch screen.

The control unit 200 may control the respective operations of the display unit 100, the touch input unit 300, and the floating execution unit 400. Further, the control unit may drop at least one graphic object floated by the floating execution unit 400 to a specific region after a screen is switched or a specific application is executed by a second touch signal of the user so as to execute a function applicable to the region.

A user may input a command signal through the touch input unit 300, and may check the input state of the command signal through the display unit 100. The touch input unit 300 may be realized in the form of a touch screen in combination with the display unit 100.

The floating execution unit 400 may generate a floating window if a long touch input associated with an object is received and maintained among the touch signals input through the touch input unit 300. The long touch input may be determined if a touch input is maintained without releasing the touch input longer than a threshold time. If the long touch input is received, a signal indicating the receipt of the long touch input may be generated and transmitted to the floating execution unit 400 for generating the floating window. Furthermore, if the floated graphic object is dropped by releasing the long touch input, the floating execution unit 400 may transmit the dropped position information to the control unit 200. If a touch input corresponding to an object is received and maintained, the object may be changed to a floated state. If the touch input is released, the floated object may be dropped and changed to a non-floated state. Further, according to aspects of the present invention, if a long touch input corresponding to an object is received and the long touch input is released, the object may be changed to a floated state. When the object is in a floated state, the object may be changed to a non-floated state in response to another touch input corresponding to the object. Further, a touch input may refer to an input associated with a contact between an object and a contact sensing device, and may include a release of a touch input, for example.

Although it is not shown in FIG. 1, the mobile device 10 may include a wireless communication unit (not shown), which enables short-distance communication, wireless internet, or mobile communication, and the like. The mobile device 10 may receive a floated graphic object transmitted from another mobile device via the wireless communication unit and realize a desired function through the floating execution unit 400.

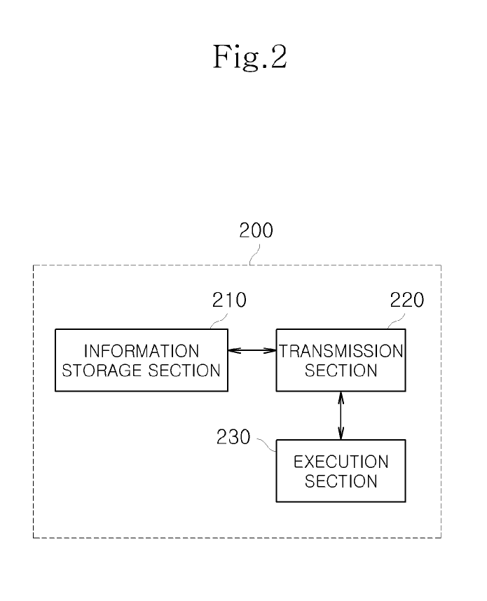

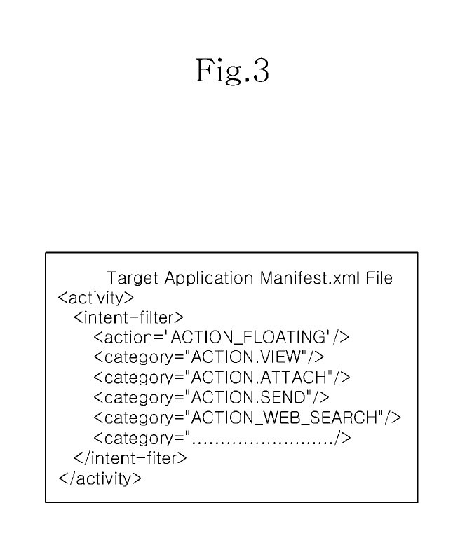

FIG. 2 is a schematic configuration diagram illustrating a control unit shown in FIG. 1 according to an exemplary embodiment of the present invention, and FIG. 3 is a diagram illustrating an example of a manifest file of a target application according to an exemplary embodiment of the present invention. Here, the manifest file may comprise all sorts of metadata of target applications and files. The term, “manifest file”, may mean such file and should not be construed as limited to the exemplary term, “manifest file”.

Referring to FIG. 2, the control unit 200 includes an information storage section 210, a transmission section 220, and an execution section 230. If a touch signal with respect to the graphic object is transmitted from the display unit 100, the information storage section 210 may store the graphic object information through parcing. The information storage section 210 may generate a floating group, which includes a plurality of graphic objects selected by a multi-touch, and store the information on the floating group.

The graphic object information may be, for example, a package name, an object type, a format, a full path, bitmap information, and the like. Moreover, the package name may store a target application and object function information shown in FIG. 3, the object type may store information for distinguishing the type of contents, a file, a list, an application, an activity, and a string, and the format may store contents format information. The full path may store a physical path to a position or a location in which contents are stored, and the bitmap information may store information displayed on a floating region.

If a drop signal with respect to the floated graphic object is input through a first touch signal, the transmission section 220 may check the floating state of the graphic object and transmit the result to a target application.

The execution section 230 may analyze the graphic object information, and execute a function defined in the application. The function may be predefined to associate the graphic object information and the application. For example, when action floating information is included in the manifest file of the target application as shown in FIG. 3, the transmission section 220 transmits the floated graphic object to the target application through a drop signal. Then, in the target application, the activity is executed if there is a function that matches a defined function of the application, such as a viewing function, an attaching function, a sending function, and a web searching function, included in the category of the graphic object, and the activity is not executed when there is not a function that matches any of defined functions.

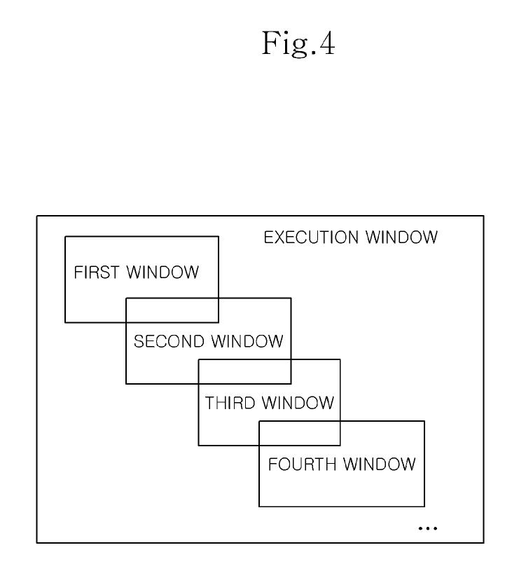

FIG. 4 is a diagram illustrating a display unit on which a plurality of windows are displayed according to an exemplary embodiment of the present invention.

Hereinafter, a process of switching the windows will be described with reference to FIG. 4.

The execution window may display an application being executed, and a user may switch the windows by inputting a drag signal while touching the execution window. For example, in a state where a plurality of windows is floated on the execution window, a first window may be displayed on the entire screen, and a second window, a third window, a fourth window, and the like may be hidden by the first window. At this time, when the user inputs a drag signal while dragging the first window, the second window located just behind the first window may be displayed on the entire screen, and the first window may be moved to the rearmost position or layer of the floated windows.

While the windows are switched as described above, the position of the graphic object that is floated by the first touch signal may be maintained even when the windows are switched. Then, if a drop signal is input, the floated graphic object may be dropped to the currently displayed window by switching into non-floating state.

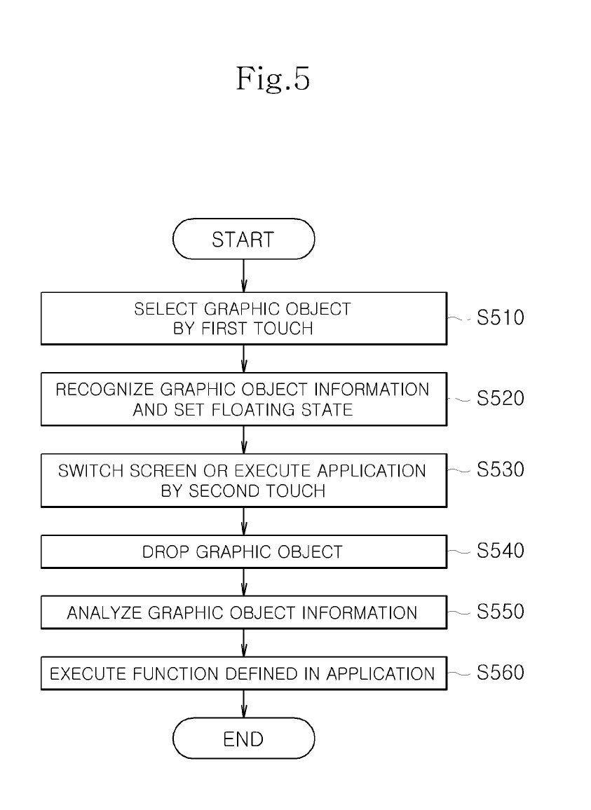

FIG. 5 is a flowchart illustrating a method for processing a floated graphic object according to an exemplary embodiment of the present invention.

Referring to FIG. 5, if a user first selects a graphic object by touching a screen corresponding to the graphic object and a first touch signal is generated through the touch input unit 300 of the mobile device 10 in operation S510, the floating execution unit 400 may analyze and store the graphic object information and set the floating state of the graphic object in operation S520.

During the floating state of the first object, the user may drag the execution window by a second touch so as to switch a screen or execute a specific application in operation S530. Here, the user may generate a floating group with a plurality of graphic objects in a manner such that other graphic objects are selected in addition to the first graphic object selected by the first touch signal and are dragged and dropped to the first graphic object, for example. If the floating group is generated, the plurality of graphic objects included in the floating group may be dropped after being moved together, and a plurality of graphic objects with similar functions may be associated with the target application to which the floating group is dropped.

Subsequently, the graphic object may be dropped onto the switched screen or the application in operation S540. The execution section 230 of the control unit 200 may analyze the graphic object information and the manifest file of the target application shown in FIG. 3 in operation S550, and execute the function that matches a function defined in the application in operation S560.

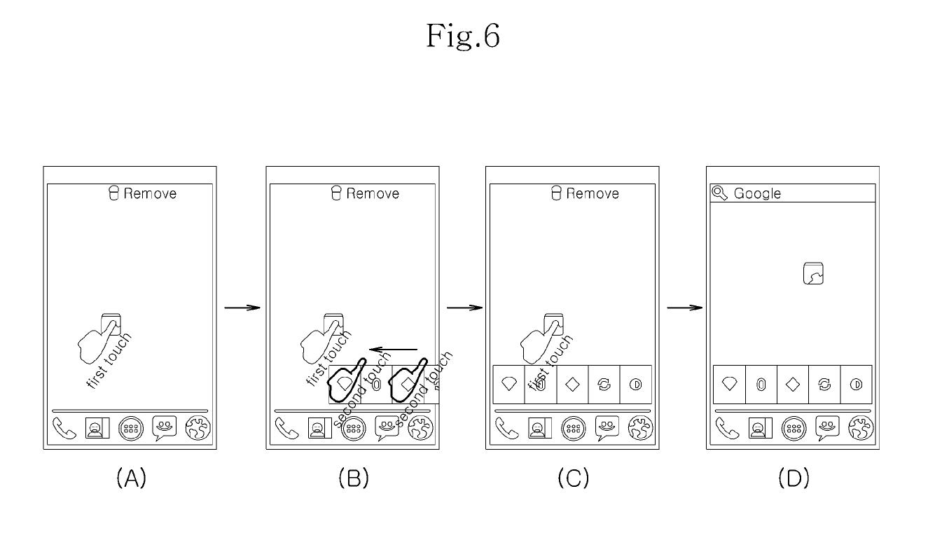

FIG. 6 through FIG. 12 are examples illustrating a method for processing a graphic object floating function according to exemplary embodiments of the present invention.

Referring to FIG. 6, if a first touch signal is input through the touch input unit 300 so as to select a graphic object as illustrated in view A, the graphic object may be changed to a floated state. In this state, if a drag signal is input by a second touch signal through the touch input unit 300 as illustrated in view B, a screen may be switched to another image in a state where the position of the floated graphic object is maintained in a current execution window. Next, if the floated graphic object is dragged and dropped as illustrated in view C and view D, the graphic object may be positioned in a desired region of the switched screen.

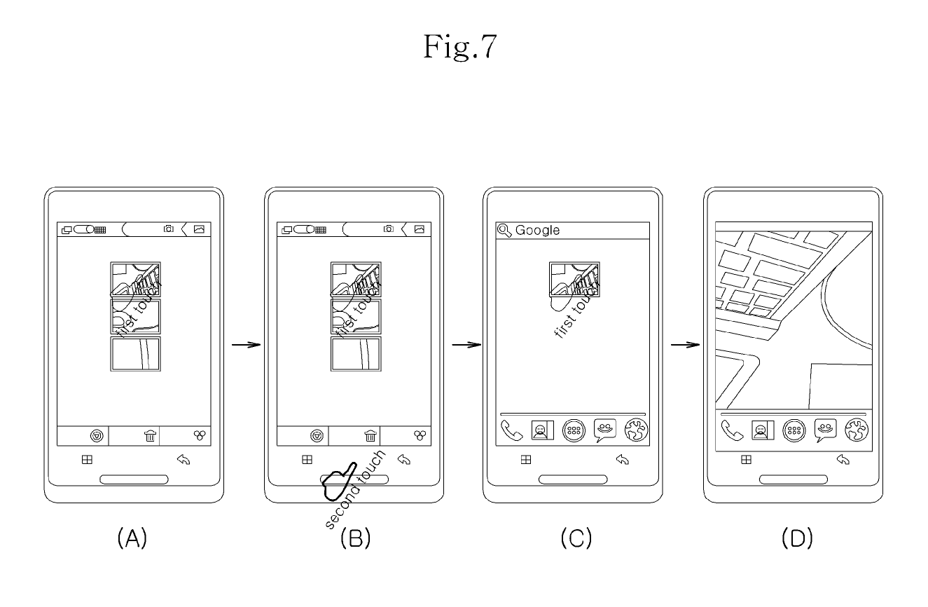

Referring to FIG. 7, if the first touch signal is input through the touch input unit 300 so as to select a graphic object in view A, the graphic object may be changed to a floated state. In this state, if a command signal for switching the displayed screen to a home screen is input by a second touch signal as illustrated in view B, the floated graphic object may be displayed on the switched home screen while maintaining the floated state as illustrated in view C. Subsequently, if a drop signal with respect to the floated graphic object is input, e.g., by releasing the first touch, the image of the graphic object may be set as a background image of the home screen. The graphic object information may include image information to set up the background image for the home screen according to the drop of the floated graphic object and a background image setting function.

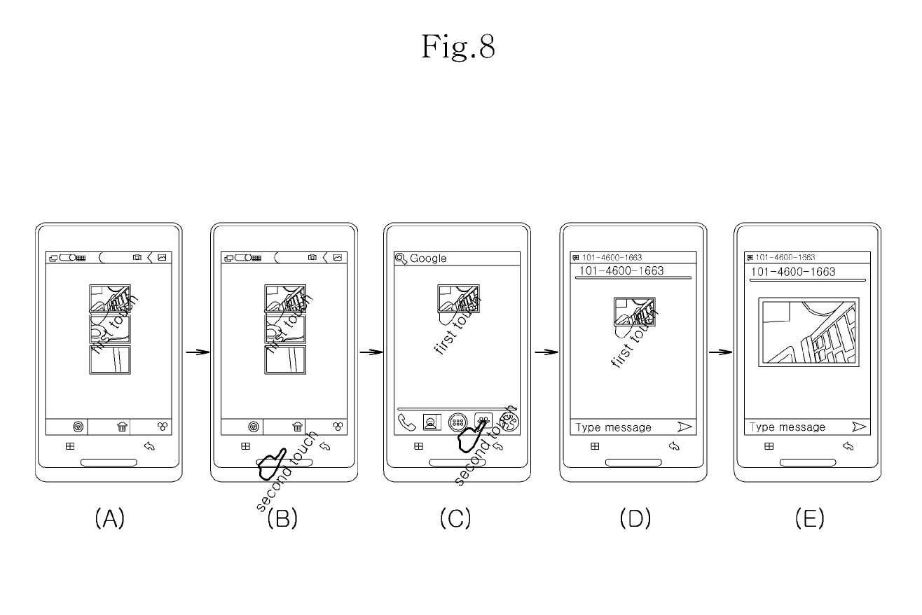

Referring to FIG. 8, if a first touch signal is input through the touch input unit 300 so as to select a graphic object as illustrated in view A, the graphic object may be changed to a floated state. In this state, if a command signal for switching the displayed screen to the home screen is input by a second touch signal as illustrated in view B, the floated graphic object may be displayed on the switched home screen as illustrated in view C. Further, if a message application executing command is input as illustrated in view C, a message screen may be displayed along with the floated graphic object as illustrated in view D, and the graphic object may be maintained in a floating state. Subsequently, if the graphic object is dropped in a state where the message screen is displayed, the graphic object may be input to the message generating screen as an attached file. For the attachment of the file associated with the floated graphic object, graphic object information may be analyzed. The graphic object information may include an attaching function, and the application may execute the attaching function.

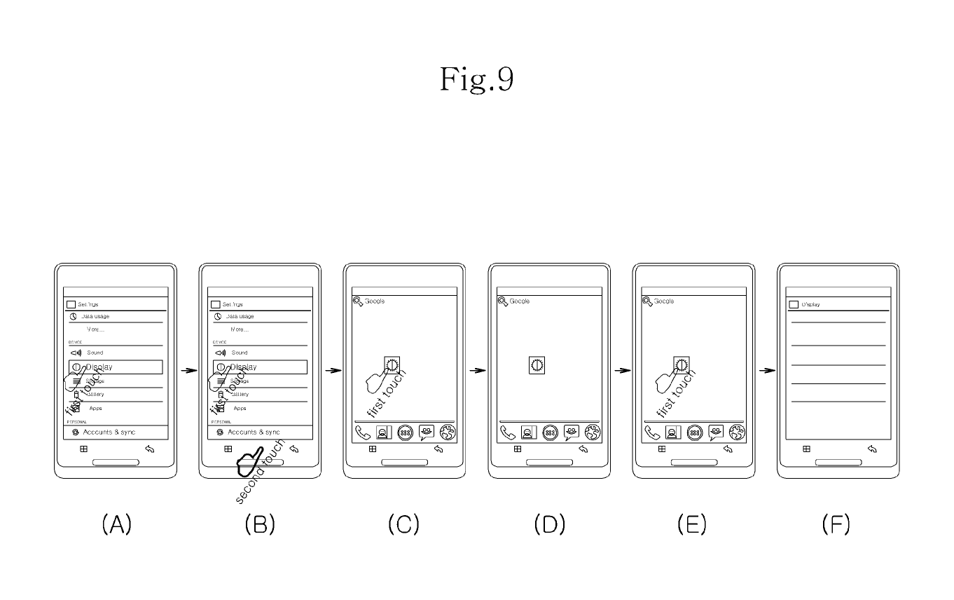

Referring to FIG. 9, if a first touch signal is input through the touch input unit 300 so as to select a graphic object of a specific application, e.g., an item in a list, as illustrated in view A, the graphic object may be changed to a floated state. In this state, if a command signal of switching a current screen to a home screen is input by a second touch signal as illustrated in view B, the floated graphic object may be displayed on the switched home screen as illustrated in view C. Next, if the floated object is dropped in view C, the graphic object may be registered on the home screen as illustrated in view D and a link may be generated to connect the registered graphic object to a corresponding function of the specific application. Subsequently, if the graphic object is touched again as illustrated in view E, the function, which is associated with the graphic object information, may be executed as illustrated in view F.

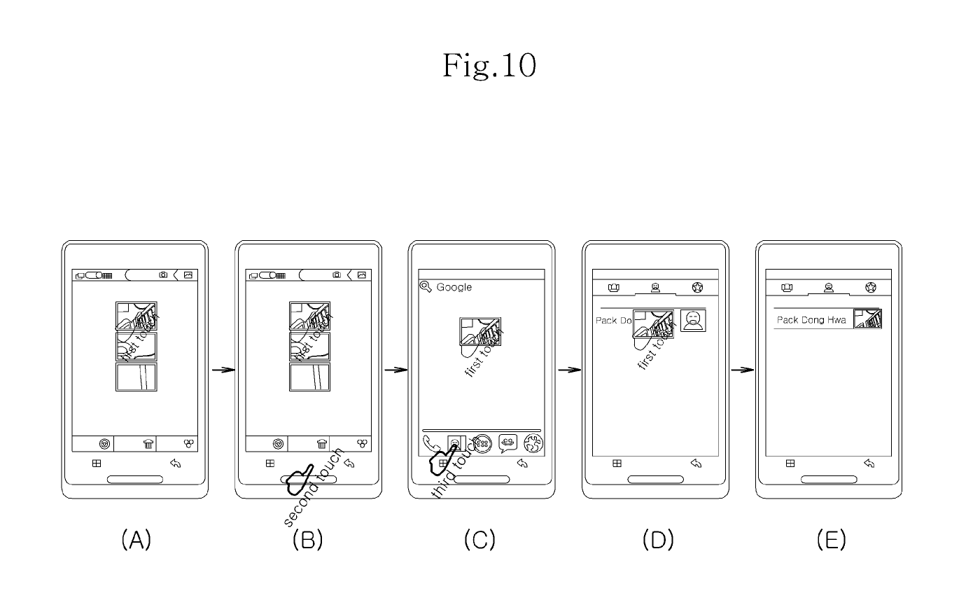

Referring to FIG. 10, if a first touch signal is input through the touch input unit 300 so as to select a graphic object as illustrated in view A, the graphic object, e.g., a picture, an audio file, and the like, is changed to a floated state. In this state, if a command signal of switching a current screen to a home screen is input by a second touch signal as illustrated in view B, the floated graphic object may be displayed on the switched home screen as illustrated in view C. Next, a third touch signal may be input so as to move to a contact group or a list as illustrated in view C. Subsequently, if the floated graphic object is dropped as illustrated in view D, a contact ring bell, a contact list image, or the like may be set according to the file format of the graphic object as illustrated in view E.

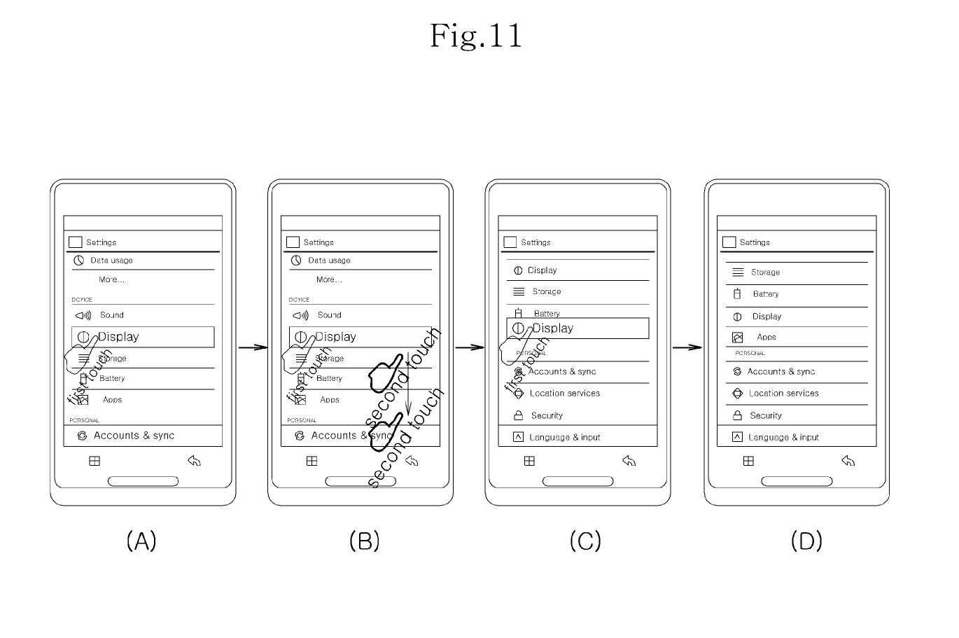

Referring to FIG. 11, if a first touch signal is input through the touch input unit 300 so as to select a graphic object on a list as illustrated in view A, the graphic object may be changed to a floated state. In this state, if the list is scrolled by a second touch signal as illustrated in view B, the list displayed on the screen may be changed while maintaining the floated graphic object in the floated state. Subsequently, if the graphic object is dropped onto a current execution window as illustrated in view C, the position of the graphic object on the list may be changed as the graphic object moves to a specific position of the list as illustrated in view D.

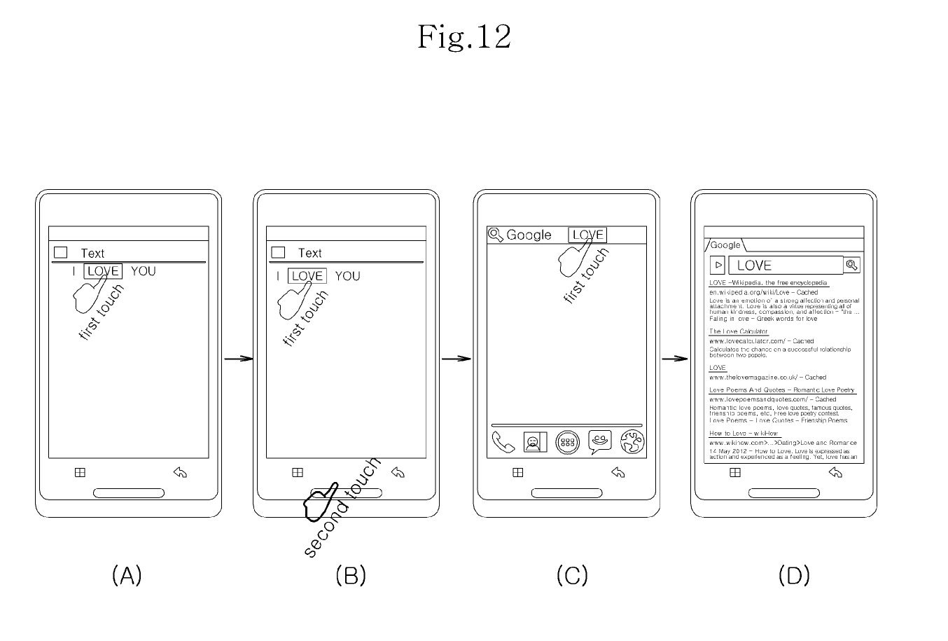

Referring to FIG. 12, a first touch signal may be input through the touch input unit 300 so as to select and float a word object, “LOVE”, in a text window as illustrated in view A. Subsequently, a second touch signal may be input so as to switch a current screen to a home screen as illustrated in view B. Subsequently, the object, “LOVE”, may be dragged and dropped into a search application displayed on the home screen as illustrated in view C. Accordingly, the search function of the search application may be executed so as to search for the word, “LOVE”, as illustrated in view D.

According to aspects of the present invention, the graphic object may be moved and the specific function intended by the user may be executed in association with the graphic object by analyzing the first-touch graphic object information, the second information, and the first-touch graphic object dropped region information using multi-touch.

Further, the plurality of graphic objects may be moved together and the function intended by the user may be executed by setting the graphic object group in a manner such that the other graphic object may be touched and dragged so as to be dropped to the first-touch graphic object while the first touch with respect to the graphic object is maintained.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile device, comprising:
a touch input display to display a first object in a first screen image and to receive a first touch input corresponding to the first object;
a floating execution unit to switch the first object into a floated state in response to the first touch input; and
a controller to execute a defined function when associating information of the first object with the second screen image or with an application corresponding to the second screen image.

2. The mobile device of claim 1, wherein the touch input display is configured to receive a second touch input when the first object is in the floated state, the second touch input replacing the first screen image with the second screen image.

3. The mobile device of claim 2, wherein the touch input display is configured to receive a third touch input corresponding to a second object, and
the floating execution unit switches the second object into a floated state and generates a floated object group comprising the floated first object and the floated second object.

4. The mobile device of claim 3, wherein the third touch input comprises a drag touch input dragging from the second object to the first object or from the first object to the second object.

5. The mobile device of claim 2, wherein the controller associates the information of the first object with the application corresponding to the second screen image in response to a third touch input.

6. The mobile device of claim 2, wherein the controller retrieves operation information of the application for a floated object, and executes an operation of the application associated with the first object based on the retrieved operation information.

7. The mobile device of claim 1, further comprising;
a memory to store information of a floated object comprising at least one of a package name, an object type, content format information, path information indicating a location of content of the floated object, and information to be displayed in the floating window.

8. The mobile device of claim 1, wherein the controller performs at least one operation of attaching the information of the first object to the second screen image or the application, searching the information of the first object using a search function of the application, linking the information of the first object to the second screen image, and relocating location of the first object in a list of the second screen image.

9. The mobile device of claim 1, wherein the touch input display comprises:
a display unit to display an application executed in the mobile device thereon; and
a touch input unit to input a command signal by a user.

10. A method for providing an object floating operation, comprising:
receiving a first touch input corresponding to a first object displayed in a first screen image;
switching the first object into a floated state in response to the first touch input;
generating a floating window for displaying the first object in the floated state, the floated first object being configured to be displayed in the floating window along with a second screen image if the first screen image is replaced with the second screen image; and
associating information of the first object with the second screen image or with an application corresponding to the second image.

11. The method of claim 10, further comprising:
receiving a second touch input when the first object is in the floated state, the second touch input replacing the first screen image with the second screen image.

12. The method of claim 11, further comprising:
receiving a third input corresponding to a second object;
switching the second object into a floated state; and
generating a floated object group comprising the floated first object and the floated second object.

13. The method of claim 12, wherein the third touch input comprises a drag touch input dragging from the second object to the first object or from the first object to the second object.

14. The method of claim 11, wherein the associating of the information of the first object is performed in response to a third touch input.

15. The method of claim 11, further comprising:
retrieving operation information of the application for a floated object, and executing an operation of the application associated with the first object based on the retrieved operation information.

16. The method of claim 10, further comprising:
storing information of a floated object comprising at least one of a package name, an object type, content format information, path information indicating a location of content of the floated object, and information to be displayed in the floating window.

17. The method of claim 10, further comprising:
performing at least one operation of attaching the information of the first object to the second screen image or the application, searching the information of the first object using a search function of the application, linking the information of the first object to the second screen image, and relocating location of the first object in a list of the second screen image.

18. A method for providing an object floating operation, comprising:
receiving a first touch input corresponding to a first object displayed in a first screen image;
switching the first object into a floated state in response to the first touch input;
receiving a second touch input associated with a second object; and
generating a floating object group for displaying the first object and the second object in a floated state.

19. The method of claim 18, further comprising:
associating information of the first and second objects with a second screen image or with an application corresponding to the second image.

20. The method of claim 19, wherein the second touch input is received before the first touch input is released, and the associating of the information of the first and second objects is performed in response to a release of the first touch input.
